(19) United States
(12) Patent Application Publication
(10) Pub. No.: US 2025/0278239 A1
(43) Pub. Date: Sep. 4, 2025

(54) DISPLAY APPARATUS AND AUDIO OUTPUTTING METHOD

(71) Applicant: SAMSUNG ELECTRONICS CO., LTD., Suwon-si (KR)

(72) Inventors: Inwoo HWANG, Suwon-si (KR); Kibeom KIM, Suwon-si (KR); Dongwoo KIM, Suwon-si (KR); Sunmin KIM, Suwon-si (KR); Haekwang PARK, Suwon-si (KR); Sangmo SON, Suwon-si (KR)

(73) Assignee: SAMSUNG ELECTRONICS CO., LTD., Suwon-si (KR)

(21) Appl. No.: 19/213,448

(22) Filed: May 20, 2025

Related U.S. Application Data
(63) Continuation of application No. PCT/KR2023/016482, filed on Oct. 23, 2023.

(30) Foreign Application Priority Data
Dec. 23, 2022 (KR) 10-2022-0183591

(51) Int. Cl. G06F 3/16; G06F 3/14

(52) U.S. Cl. CPC G06F 3/165; G06F 3/14

(57) ABSTRACT

A display apparatus includes a content receiver configured to receive content data from a content source; an audio output device configured to output a sound corresponding to the content data; one or more processors; and memory storing instructions, wherein the instructions, when executed by the one or more processors, cause the display apparatus to determine a threshold volume based on a first average volume of the sound that is output by the audio output device for a first reference time; determine a compensation value based on a second average volume of the sound that is output by the audio output device for a second reference time; and control the audio output device to adjust a volume of the sound that is output based on the threshold volume and the compensation value.

### CROSS-REFERENCE TO RELATED APPLICATIONS

This application is a bypass continuation application of International Application No. PCT/KR2023/016482, filed on Oct. 23, 2023, which is based on and claims priority to Korean Patent Application No. 10-2022-0183591, filed on Dec. 23, 2022, in the Korean Intellectual Property Office, the disclosures of which are incorporated by reference herein in their entireties.

### BACKGROUND

### 1. Field

The disclosure relates to a display apparatus and audio outputting method.

### 2. Description of Related Art

Display apparatuses may visually present image information received or stored to a user, and display apparatuses may be used in various areas such as homes or businesses. Different types of display apparatuses may be used, such as monitor devices connected to personal computers (PCs) or server computers, portable computer systems, Global Positioning System (GPS) terminals, television sets, Internet protocol televisions (IPTVs), portable terminals, e.g., smart phones, tablet PCs, personal digital assistants (PDAs), and cellular phones, other display apparatus for reproducing images like advertisements or films, or other various kinds of audio/video systems.

Display apparatuses may receive content from various content sources such as a broadcasting station, an Internet server, a video playback device, a game device and/or a portable terminal. Display apparatuses may reconstruct images and sound from the content and may output the reconstructed images and sound.

Research is being conducted not only image processing, but also on audio processing for display apparatuses. For example, technologies to maintain output sound at a constant volume are being researched.

### SUMMARY

Provided are a display apparatus and sound outputting method which may control the volume of output sound to be constant regardless of input content.

According to an aspect of the disclosure, a display apparatus includes a content receiver configured to receive content data from a content source; an audio output device configured to output a sound corresponding to the content data; one or more processors; and memory storing instructions, wherein the instructions, when executed by the one or more processors, cause the display apparatus to determine a threshold volume based on a first average volume of the sound that is output by the audio output device for a first reference time; determine a compensation value based on a second average volume of the sound that is output by the audio output device for a second reference time; and control the audio output device to adjust a volume of the sound that is output based on the threshold volume and the compensation value.

The second reference time may be shorter than the first reference time.

The threshold volume may be larger than the first average volume.

The instructions, when executed by the one or more processors, may cause the display apparatus to determine an auxiliary value based on at least one of a volume set for the display apparatus or the content data, and determine the threshold volume by adding the auxiliary value to the first average volume.

The instructions, when executed by the one or more processors, may cause the display apparatus to determine a difference between a predetermined reference volume and the second average volume as the compensation value.

The instructions, when executed by the one or more processors, may cause the display apparatus to control the audio output device to output the sound by adjusting the volume of the sound to the threshold volume based on the volume of the sound that is output exceeding the threshold volume.

The instructions, when executed by the one or more processors, may cause the display apparatus to control the audio output device to output the sound by adding the compensation value to the volume of the sound that is output based on the volume of the sound that is output being less than a predetermined reference volume.

The instructions, when executed by the one or more processors, may cause the display apparatus to determine whether content is changed based on the content data; and re-determine the first average volume and the threshold volume based on the content being changed.

The instructions, when executed by the one or more processors, may cause the display apparatus to adjust the volume of the sound to be constant.

According to an aspect of the disclosure, a sound outputting method includes receiving content data from a content source; outputting a sound corresponding the content data; determining a threshold volume based on a first average volume of the sound that is output for a first reference time; determining a compensation value based on a second average volume of the sound that is output for a second reference time; and adjusting a volume of the sound that is output based on the threshold volume and the compensation value.

The second reference time may be shorter than the first reference time.

The determining the threshold volume may include determining the threshold volume to be larger than the first average volume.

The determining the threshold volume may include determining an auxiliary value based on at least one of a volume set for a display apparatus or the content data; and determining the threshold volume by adding the auxiliary value to the first average volume.

The determining the compensation value may include determining a difference between a predetermined reference volume and the second average volume as the compensation value.

The adjusting the volume of the sound that is output may include adjusting the volume of the sound that is output to the threshold volume based on the volume of the sound that is output exceeding the threshold volume.

The adjusting the volume of the sound that is output may include adding the compensation value to the volume of the sound that is output in response to the volume of the sound that is output being less than a predetermined reference volume.

The sound outputting method may further include determining whether content is changed based on the content data; and re-determining the first average volume and the threshold volume based on the content being changed.

The adjusting the volume of the sound that is output may include adjusting the volume of the sound that is output to be constant.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates an exterior of a display, according to an embodiment;

FIG. 2 is a block diagram of a display, according to an embodiment;

FIG. 3 is a block diagram of a controller included in a display apparatus, according to an embodiment;

FIG. 4 is a flowchart describing determination of a threshold volume, according to an embodiment;

FIG. 5 is a flowchart describing determination of a compensation value, according to an embodiment; and

FIG. 6 is a flowchart describing adjustment of an audio volume based on a threshold volume and a compensation value, according to an embodiment.

### DETAILED DESCRIPTION

The embodiments described in the disclosure, and the configurations shown in the drawings, are only examples of embodiments, and various modifications may be made without departing from the scope and spirit of the disclosure.

It will be further understood that the term “connect” or its derivatives refer both to direct and indirect connection, and the indirect connection includes a connection over a wireless communication network.

The terminology used herein is for the purpose of describing embodiments and is not intended to limit the disclosure. It is to be understood that the singular forms “a,” “an,” and “the” include plural references unless the context clearly dictates otherwise. It will be further understood that the terms “comprise” and/or “comprising,” when used the disclosure, indicate the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are for the purpose of distinguishing a component from another. For example, a first element could be termed a second element and vice versa, without departing from the scope of the disclosure.

The terms, such as “˜ part”, “˜ block”, “˜ member”, “˜ module”, for example, may refer to a unit of handling at least one function or operation. For example, the terms may refer to at least one process handled by hardware such as field-programmable gate array (FPGA)/application integrated circuit (ASIC), for example, software stored in a memory, or at least one processor.

The expressions “at least one of A, B and C” and “at least one of A, B, or C”, both indicate “A”, only “B”, only “C”, both “A and B”, both “A and C”, both “B and C”, and all of “A, B, and C”.

Reference numerals used for method steps are just used to identify the respective steps, but not to limit an order of the steps. Unless the context clearly dictates otherwise, the written order may also be practiced.

Reference will now be made in detail to embodiments of the disclosure, which are illustrated in the accompanying drawings.

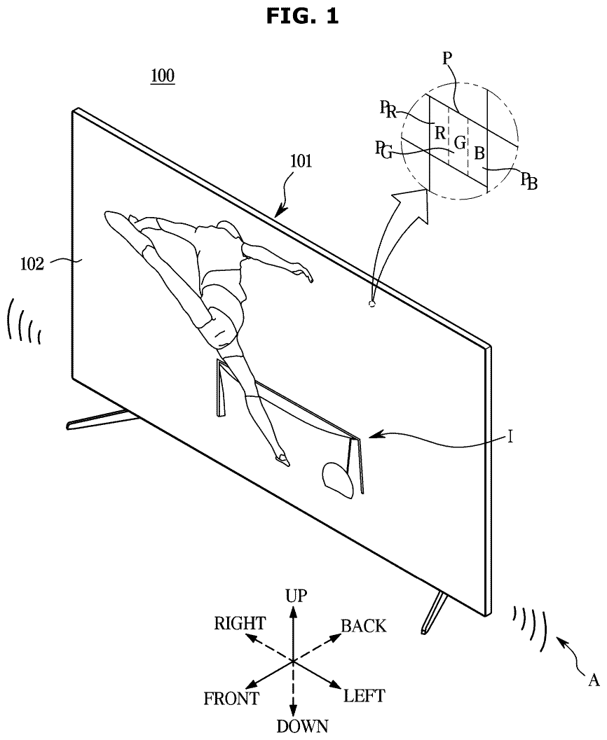

FIG. 1 illustrates an exterior of a display, according to an embodiment.

A display apparatus 100 is a device that is able to process image signals received from the outside and visually present the processed image. For example, the display apparatus 100 may be implemented in various product forms such as a television (TV), a monitor, a portable multimedia device, a portable communication device, or a portable operation device, for example, and the display apparatus 100 is not limited to a particular form as long as it is capable of visually reproducing image signals and audibly reproducing audio signals.

The display apparatus 100 may be a large format display (LFD) installed outdoors such as on a rooftop of a building or at a bus stop. The display apparatus 100 may not be exclusively installed outdoors, but may be installed at any place, even indoors with foot traffic, for example, at subway stations, shopping malls, theaters, offices, or stores.

The display apparatus 100 may receive contents including video and sound from various content sources and output video and sound included in the content. For example, the display apparatus 100 may receive television (TV) broadcast content through a broadcast receiving antenna or a cable, receive multimedia content from a content reproducing device through a multimedia cable, or receive streaming content from a content streaming server over a communication network.

As shown in FIG. 1, the display apparatus 100 may include a main body 101 that accommodates a plurality of components for displaying images, and a display panel 102 arranged on one side of the main body 101 for displaying image I.

The main body 101 forms the exterior of the display apparatus 100, and components for the display apparatus 100 to output the image I and sound A may be arranged in the main body 101. The main body 101 shown in FIG. 1 is shaped like a flat plate, but the shape of the main body 101 is not limited thereto, and the main body 101 may have a curved form with left and right ends relatively coming forward and the other parts curved backward.

The display panel 102 may be formed on the front of the main body 101 for displaying visual information, for example, the image I. For example, the display panel 102 may display still or moving images in two dimension (2D) or three dimension (3D).

A plurality of pixels P are formed on the display panel 102, and the image I displayed on the display panel 102 may be formed by a combination of rays emitted by the plurality of pixels P. For example, the rays emitted by the plurality of pixels P may be combined like a mosaic and formed into one image I on the display panel 102.

The plurality of pixels P may each emit light in various colors and brightnesses.

To emit light with different brightness, each of the plurality of pixels P may include an element that may emit light directly (e.g., an organic light emitting diode (OLED)) or an element capable of transmitting or blocking light illuminated by e.g., a backlight unit (e.g., a liquid crystal panel).

Each of the pixels P may include subpixels PR, PG, and PB to emit different colors of light. The subpixels PR, PG, and PB may include a red subpixel PR to emit red light, a green subpixel PG to emit green light, and blue subpixel PB to emit blue light. For example, the red subpixel PR may emit red light having a wavelength of about 620 nanometers (nm, a billionth of a meter) to about 750 nm; the green subpixel PG may emit green light having a wavelength of about 495 nm to about 570 nm; the blue subpixel PB may emit blue light having a wavelength of about 450 nm to about 495 nm.

By combinations of the red light of the red subpixel PR, the green light of the green subpixel PG, and the blue light of the blue subpixel PB, each of the pixels P may emit various brightnesses and colors of light.

The main body 101 may be equipped with a speaker on the rear side or a lateral side to output the sound A. The speaker may output the sound A included in the content received by the display apparatus 100 from a content source.

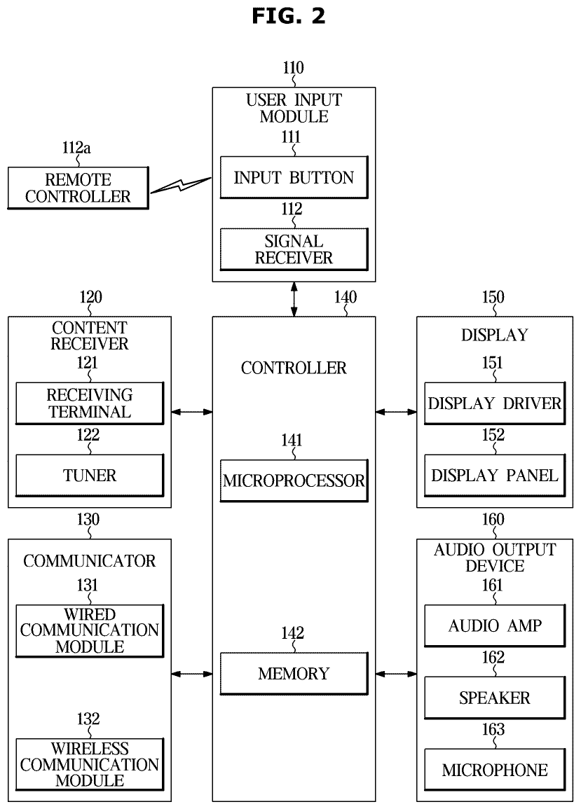

FIG. 2 is a block diagram of a display, according to an embodiment.

The display apparatus 100 includes a user input module 110 for receiving a user input from the user, a content receiver (or content receiving part) 120 for receiving video/audio content from a content source, a communicator 130 for communicating with the content source, a controller (or control part) 140 for processing the video/audio content received by the content receiver 120 and/or the communicator 130, a display 150 for displaying an image processed by the controller 140, and an audio output device (or audio part) 160 for outputting sound processed by the controller 140.

The user input module 110 may include an input button 111 for receiving a user input. For example, the user input module 110 may include a power button for turning on or off the display apparatus 100, a channel selection button for select a broadcast content to be displayed on the display apparatus 100, a sound control button for controlling audio volume output by the display apparatus 100, or a source selection button for selecting a content source, for example.

The input button 111 may receive a user input and output an electric signal corresponding to the user input to the controller 140, and may be implemented by various input means such as a push switch, a touch switch, a dial, a slide switch, or a toggle switch, for example.

The user input module 110 may also include a signal receiver 112 for receiving a remote control signal from a remote controller 112a. The remote controller 112a for receiving a user input may be provided separately from the display apparatus 100, may receive a user input and transmit a radio signal corresponding to the user input to the display apparatus 100. The signal receiver 112 may receive a radio signal corresponding to a user input from the remote controller 112a, and output an electric signal corresponding to the user input to the controller 140.

The content receiver 120 may include a receiving terminal 121 to receive video/audio content including image data and audio data from a content source, and a tuner 122 to receive a broadcast signal including TV broadcast content and tune to the received broadcast signal.

The receiving terminal 121 may be connected to the content source through a cable to receive video/audio content including image data and audio data from the content source. The video/audio content may be received in a data stream format, and the data stream of the video/audio content (hereinafter, referred to as content data) may be generated by encoding the image data and the audio data.

The receiving terminal 121 may include a component (YPbPr/RGB) terminal and a composite video blanking and sync (CVBS) terminal to receive analog image frame data. The receiving terminal 121 may include a high-definition multimedia interface (HDMI) terminal to receive digital image frame data. The receiving terminal 121 may also include a universal serial bus (USB) terminal to receive image data from an external storage medium (e.g., a USB drive).

The tuner 122 may receive broadcast signals through a broadcast receiving antenna or a cable, and extract a broadcast signal on a channel selected by the user from among the broadcast signals. For example, the tuner 122 may pass a TV broadcast signal having a frequency corresponding to a channel selected by the user among multiple TV broadcast signals of various frequencies received through the broadcast receiving antenna 2, and block TV broadcast signals having the other frequencies. The TV broadcast signal may be generated by modulating the data stream of the content, and the display apparatus 100 may generate content data by demodulating the TV broadcast signal.

As such, the content receiver 120 may receive video/audio content from the content source, and output the video/audio content to the controller 140.

The communicator 130 may exchange data with the content source and/or the external device over a communication network. For example, the communicator 130 may receive video/audio content from the content source, or receive information about the video/audio content from the external device. The information about the video/audio content is information about content itself, including a title, type, or genre, for example, of the content.

The communication network may include both wired and wireless communication networks. The wired communication network may include a communication network such as a cable network or a telephone network, and the wireless communication network may include a communication network for transmitting and receiving signals on radio waves. The wireless communication network may also include an access point (AP), and the AP may be connected to the image processing apparatus 100 and connected to the wired communication network via cable.

The communicator 130 may include a wired communication module 131 for exchanging data with the content source and/or the external device on wire, and a wireless communication module 132 for exchanging data with the content source and/or the external device wirelessly.

The wired communication module 131 may access a wired communication network and communicate with the content source over the wired communication network. For example, the wired communication module 131 may access the wired communication network through Ethernet (IEEE 802.3 technology standard), and receive data from the content source and/or the external devices over the wired communication network.

The wireless communication module 132 may communicate wirelessly with a base station or an access point (AP), and access the wired communication network via the base station or the AP. The wireless communication module 132 may communicate with the content source and/or the external devices connected to the wired communication network via a base station or the AP. For example, the wireless communication module 132 may use wireless fidelity (Wi-Fi) (the IEEE 802.11 technology standard), to communicate with an AP, or use code divisional multiple access (CDMA), wideband code division multiple access (WCDMA), Global Systems for Mobile communications (GSM), Long Term Evolution (LTE), or WiBro, for example, to communicate with a base station. The wireless communication module 132 may receive data from the content source and/or the external device via the base station or the AP.

The wireless communication module 132 may communicate directly with the content source and/or the external device. For example, the wireless communication module 132 may use Wi-Fi, Bluetooth (IEEE 802.15.1 technology standard), or ZigBee (IEEE 802.15.4 technology standard), for example, to wirelessly receive data from the content source and/or the external device.

As such, the communicator 130 may receive video/audio content and/or information about the video/audio content from the content source and/or the external device through the wired communication module 131 and/or the wireless communication module 132, and output the received video/audio content and/or information about the video/audio content to the controller 140 through the wired communication module 131 and/or the wireless communication module 132.

The controller 140 may control the content receiver 120, the communicator 130, the display 150 and/or the audio output device 160 according to a user input received through the user input module 110. For example, on receiving a user input to select a content source, the controller 140 may control the content receiver 120 and/or the communicator 130 to receive content data from the selected content source. On receiving a user input for image adjustment and/or sound adjustment, the controller 140 may control the display 150 and/or the audio output device 160 to adjust the image and/or sound.

The controller 140 may process image data and/or audio data received by the content receiver 120 and/or the communicator 130. For example, the controller 140 may reconstruct image data by decoding the content data, and output the reconstructed image data through the display 150. The controller 140 may reconstruct the audio data by decoding the content data, and generate an analog audio data (hereinafter, audio signal) by processing audio data.

The controller 140 may process the audio signal to provide a constant volume. For example, a constant volume of the sound may be provided by reducing a relatively large volume in the audio signal and increasing a relatively small volume.

The controller 140 may include a microprocessor 141 and a memory 142.

The memory 142 may store programs and/or data for controlling components of the display apparatus 100, and temporarily store control data produced while the components of the display apparatus 100 is being controlled.

The memory 142 may also store programs and data for decoding the content data received by the content receiver 120 and/or the communicator 130, and temporarily store image data and/or audio data produced while the content data is being decoded.

The memory 142 may include a non-volatile memory, such as a Read Only Memory (ROM), a flash memory, and/or the like, which may store data for a long period, and a volatile memory, such as a static random access memory (SRAM), a dynamic RAM (DRAM), or the like, which may temporarily store data.

The microprocessor 141 may receive content data from the content receiver 120 and/or the communicator 130. The microprocessor 141 may decode content data based on the program and data stored in the memory 142, and reconstruct the image data and audio data.

The microprocessor 141 may also be trained to process audio data based on user inputs and environmental information such as content genres, audio properties, audio mode, audio volume, external noise, or viewing time (or duration), for example, and generate an analog audio signal by processing the audio data according to the training result.

The microprocessor 231 may include an operation circuit for performing a logic operation and an arithmetic operation, and a memory circuit for storing the data resulting from the operation.

The display 150 includes a display panel 152 for visually reproducing images, and a display driver 151 for driving the display panel 152.

The display panel 152 may include pixels, each pixel being a unit for displaying images. Each pixel may receive an electric signal representing an image from the display driver 151, and output an optical signal corresponding to the received electric signal. As such, optical signals output from the plurality of pixels P may be combined into one image to be displayed on the display panel 152.

For example, a plurality of pixels may be arranged on the display panel 152, and an image displayed on the display panel 152 may be formed by a combination of rays emitted from the plurality of pixels. For example, the rays emitted by the plurality of pixels may be combined like mosaics into an image on the display panel 152. Each of the plurality of pixels may emit various brightnesses and colors of light, and each of the plurality of pixels may include a red subpixel, a green subpixel and a blue subpixel to emit various colors of light.

The display panel 152 may be implemented by various types of panels such as a liquid crystal display panel (LCD panel), a light emitting diode panel (LED panel), or an organic light emitting diode panel (OLED panel), for example.

The display driver 151 may receive image data from the controller 140, and drive the display panel 152 to display an image corresponding to the received image data. The display driver 151 may send an electric signal corresponding to the image data to each of the plurality of pixels of the display panel 152.

When the display driver 151 sends an electric signal corresponding to the image data to each pixel of the display panel 152, the pixel may output a ray corresponding to the electric signal and rays output by the respective pixels may be combined into an image.

The audio output device 160 includes an audio amp 161 for amplifying sound, a speaker 162 for audibly outputting the amplified sound and a microphone 163 for collecting surrounding sound.

The controller 140 may process audio data to be converted to an audio signal, and the audio amp 161 may amplify the audio signal output from the controller 140.

The speaker 162 may convert the audio signal amplified by the audio amp 161 to a sound (sound waves). For example, the speaker 162 may include a thin film that vibrates according to an electric audio signal, and the vibration of the thin film may produce sound waves.

The microphone 163 may collect sounds around the display apparatus 100, and convert the collected sound into an electric audio signal. The audio signal collected by the microphone 163 may be output to the controller 140.

The display apparatus 100 may receive contents including video and audio signals from various content sources and output the video and audio signals included in the content.

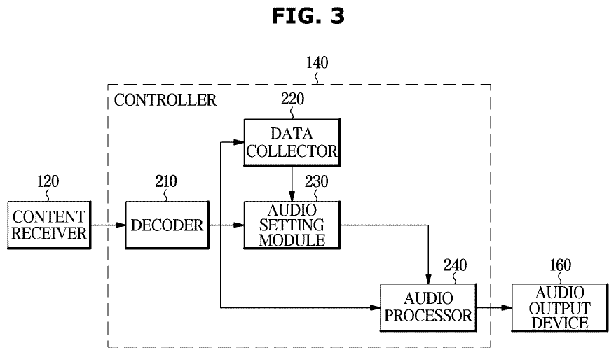

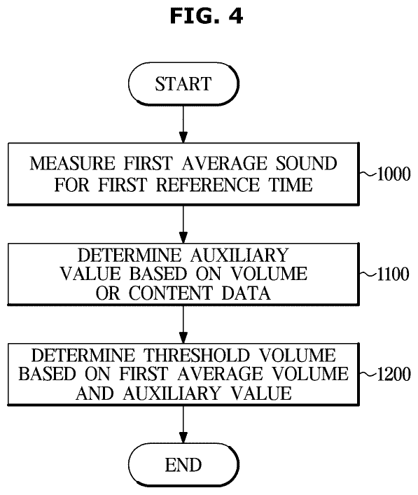

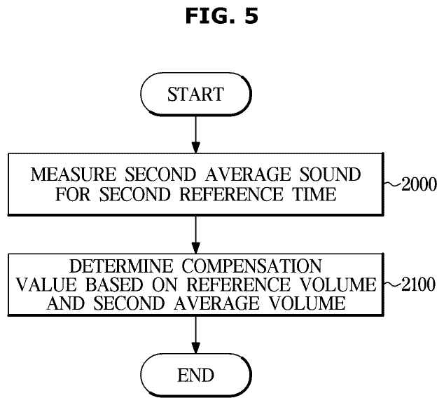

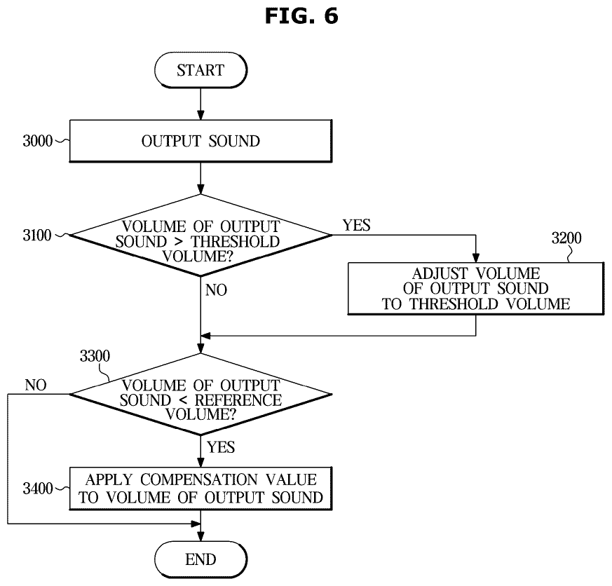

FIG. 3 is a block diagram of a controller included in a display apparatus, according to an embodiment, FIG. 4 is a flowchart describing determination of a threshold volume, according to an embodiment, FIG. 5 is a flowchart describing determination of a compensation value, according to an embodiment, and FIG. 6 is a flowchart describing adjustment of an audio volume based on a threshold volume and a compensation value, according to an embodiment.

The controller 140 includes a decoder 210, a data collector (or data collection part) 220, an audio setting module (or audio setting part) 230 and an audio processor (audio processing part) 240. The decoder 210, the data collector 220, the sound setting module 230 and the audio processor 240 may be implemented by an application (software) stored in the memory 142 and running by the microprocessor 141, or implemented by a digital circuit (hardware) mounted in the microprocessor 141.

The decoder 210 may reconstruct image data and audio data by decoding the content data. The content data may be compressed/encoded according to various compression/encoding standards. For example, the image data of the content data may be compressed/encoded using an image compression standard such as H.264/Moving Picture Experts Group-4 Advanced Video Coding (MPEG-4 AVC), or H.265/High Efficiency Video Coding (HEVC), for example. The audio data may be compressed/encoded using an audio compression standard such as Advanced Audio Coding (AAC), or MPEG-H 3D Audio, for example.

The decoder 210 may reconstruct image data from the content data by using an image compression standard, and reconstruct audio data from the content data by using an audio compression standard.

The decoder 210 may output the audio data to the data collector 220, the audio setting module 230 and the audio processor 240.

The data collector 220 may collect information for outputting a constant volume (hereinafter, referred to as audio information). For example, the data collector 220 may collect audio properties, audio mode, audio volume, external noise, current time and time duration of the content.

The data collector 220 may determine audio properties of the content. The audio properties of the content may vary depending on genres of the content, and the genres of the content may include news, dramas, entertainments, sports, documentaries, films, comedies, or music, for example.

The data collector 220 may determine the genre of the content by analyzing metadata related to the content. The metadata is information about attributes of the content, including various information that describes the content such as the location and description of the content, information about a creator, or information about the genre, for example. Hence, on receiving the meta data of content data along with the content data, the data collector 220 may determine a genre of the content by analyzing the metadata. The data collector 220 may determine audio properties of the content based on the genre of the content.

The data collector 220 may determine a genre of the content and/or a genre of the sound by analyzing the audio data itself in the content. For example, the data collector 220 may determine a genre of the content and/or a genre of the sound by using a genre recognition model. The genre recognition model may be generated in advance through machine learning based on plenty of data for training. The data collector 220 may also determine a genre of the content and/or a genre of the sound based on audio data of a portion of the content.

The data collector 220 may determine a currently set audio mode. The audio mode may indicate an operation mode of the display apparatus 100 regarding audio processing, and depending on the audio mode, the sound amplification factor for each frequency band and the sound amplification factor of voice sound and background sound may be different.

The display apparatus 100 may receive a selection of audio mode from the user through the user input module 110. The audio setting module 230 may output different audio settings depending on different audio modes, and the audio processor 240 may generate an audio signal by processing audio data based on different audio settings depending on different audio modes.

The audio processor 240 may operate in various audio modes depending on user inputs, and the data collector 220 may collect information about an audio mode of the audio processor 240 based on the user input.

The data collector 220 may determine an audio volume based on the user input through the user input module 110. For example, based on a user input through the input button 111, or a volume up button or a volume down button equipped in the remote controller 112a, the audio volume may be determined.

The data collector 220 may determine external noise around the display apparatus 100 based on an audio signal collected through the microphone 163. For example, the data collector 220 may determine a level of the external noise based on the magnitude of the audio signal collected through the microphone 163.

The data collector 220 may determine current time and time duration of the user based on an output of a timer included in the controller 140. The controller 140 may receive information about the current time from an external device through the communicator 130, or use the timer to compute the current time based on a time setting of the user.

The audio setting module 230 may receive audio data from the decoder 210 and receive audio information from the data collector 220.

The audio setting module 230 may generate a volume setting value for audio processing based on the audio data and audio information. The volume setting value may include an auxiliary value, a threshold volume, or a compensation value, for example.

Referring to FIG. 4, described is a method of determining the threshold volume.

The threshold volume refers to a volume that is a basis for determining whether an output volume in the volume signal is relatively large.

The audio setting module 230 may determine a threshold volume based on a first average volume and an auxiliary value.

The first average volume refers to an average volume value of the audio signal measured for a first reference time (e.g., 1 minute, a content reproduction time).

The audio setting module 230 may measure the first average volume for the first reference time, in 1000. For example, the audio setting module 230 may measure a volume of the audio signal for one minute, and then measure the first average volume by applying Root Mean Square. The measuring of the average volume is not limited thereto, and there are no limitations on methods for measuring an average volume of the audio signal. For example, the audio setting module 230 may measure an average volume of the audio signal through a standard scheme such as ITU-R BS.1770-3, algorithms to measure audio programme loudness and true-peak audio level.

The audio setting module 230 may measure the first average volume again in response to a user input (e.g., channel switching) or a change in content.

The auxiliary value refers to a value to be added to the first average volume to determine a threshold volume.

The audio setting module 230 may determine the auxiliary value based on the audio information. The audio setting module 230 may determine the auxiliary value based on at least one of a volume set for the display apparatus or content data, in 1100.

For example, the audio setting module 230 may determine the auxiliary value to be inversely proportional to the volume set for the display apparatus, and when the genre of the content is sports having large volume variations, the auxiliary value may be determined to be large, and when the genre of the content is dramas having small volume variations, the auxiliary value may be determined to be small.

The audio setting module 230 may determine the auxiliary value to be large when the user sets a large volume variation range, and determine the auxiliary value to be small when the user sets a small volume variation range.

The audio setting module 230 may determine a threshold volume based on the first average volume and the auxiliary value, in 1200. The audio setting module 230 may determine the threshold volume again in response to a user input (e.g., channel switching) or a change in content.

The audio setting module 230 may determine the first average volume as the threshold volume, or determine the threshold volume by adding the auxiliary value to the first average volume.

For example, when the first average volume measured for one minute is −24 dB LKFS and the auxiliary value according to a user setting is 3 dB LKFS, the audio setting module 230 may determine the first average volume of −24 dB LKFS as the threshold volume, or determine −21 dB LKFS resulting from addition of the auxiliary value (3 dB LKFS) to the first average volume (−24 dB LKFS) as the threshold volume.

Referring to FIG. 5, described is a method of determining a compensation value.

The compensation value refers to a value to be added to the audio signal to keep an output volume constant. The compensation value may be determined based on a second average volume and a reference volume.

The audio setting module 230 may measure the second average volume for a second reference time, in 2000. For example, the audio setting module 230 may measure a volume of the audio signal for one second, and then measure the second average volume by applying Root Mean Square. The measuring of the average volume is not limited thereto, and there are no limitations on methods for measuring an average volume of the audio signal. For example, the audio setting module 230 may measure an average volume of the audio signal through a standard scheme such as ITU-R BS.1770-3, algorithms to measure audio programme loudness and true-peak audio level.

The compensation value may be determined based on an average value calculated within a short time as the compensation value is a value to be added to an output audio signal to have a large output volume. The second reference time is shorter than the first reference time.

The reference volume refers to a volume at which the user may listen to sound without discomfort. For example, the reference volume may be −24 dB LKFS. The reference volume may be stored in the memory 142.

The audio setting module 230 may determine the compensation value based on the reference volume (e.g., −24 dB LKFS) and the second average volume, in 2100.

The sound setting module 230 may determine a difference between the reference volume and the second average volume as the compensation value. For example, when the reference volume is −24 dB LKFS and the second average volume is −30 dB LKFS, the sound setting module 230 may determine 6 dB LKFS, which is a difference between the reference volume (−24 dB LKFS) and the second average volume (−30 dB LKFS), as the compensation value.

The audio setting module 230 may transmit a volume setting value including the determined threshold volume and the compensation value to the audio processor 240.

Referring to FIG. 6, described is a method of adjusting a volume based on the threshold volume and the compensation value.

The audio processor 240 may receive audio data from the decoder 210 and receive audio setting value from the audio setting module 230. The audio processor 240 may generate an audio signal by processing the audio data based on the volume setting value. The audio processor 240 may output the audio signal to the audio output device 160. The audio output device 160 may output a sound according to the audio signal, in 3000.

The audio processor 240 may compare the volume of the output sound with the threshold volume, in 3100.

When the volume of the output sound exceeds the threshold volume in 3100, the volume of the output sound may be adjusted to the threshold volume, in 3200.

For example, when the volume of the output sound is −14 dB LKFS and the threshold volume is −27 dB LKFS, the audio processor 240 may adjust the volume of the output sound to −27 dB LKFS.

When the volume of the output sound is equal to or less than the threshold volume in 3100, the volume of the output sound may be compared with the reference volume, in 3300. The audio processor 240 may compare the volume of the output sound adjusted to the threshold volume with the reference volume.

When the volume of the output sound is less than the reference volume in 3300, the compensation value may be added to the volume of the output sound, in 3400. For example, when the adjusted volume of the output sound is −27 dB LKFS and the reference volume is −24 dB LKFS, the audio processor 240 may add the compensation value (3 dB LKFS) to the adjusted volume of the output sound (−27 dB LKFS).

The audio processor 240 may output the adjusted audio signal to the audio output device 160. The audio output device 160 may output a sound according to the adjusted audio signal.

The embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, or an optical data storage device, for example.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A display apparatus comprising:
a content receiver configured to receive content data from a content source;
an audio output device configured to output a sound corresponding to the content data;
one or more processors; and
memory storing instructions,
wherein the instructions, when executed by the one or more processors, cause the display apparatus to:
determine a threshold volume based on a first average volume of the sound that is output by the audio output device for a first reference time;
determine a compensation value based on a second average volume of the sound that is output by the audio output device for a second reference time; and
control the audio output device to adjust a volume of the sound that is output based on the threshold volume and the compensation value.

2. The display apparatus of claim 1, wherein the second reference time is shorter than the first reference time.

3. The display apparatus of claim 1, wherein the threshold volume is larger than the first average volume.

4. The display apparatus of claim 3, wherein the instructions, when executed by the one or more processors, cause the display apparatus to:
determine an auxiliary value based on at least one of a volume set for the display apparatus or the content data, and
determine the threshold volume by adding the auxiliary value to the first average volume.

5. The display apparatus of claim 1, wherein the instructions, when executed by the one or more processors, cause the display apparatus to determine a difference between a predetermined reference volume and the second average volume as the compensation value.

6. The display apparatus of claim 1, wherein the instructions, when executed by the one or more processors, cause the display apparatus to control the audio output device to output the sound by adjusting the volume of the sound to the threshold volume based on the volume of the sound that is output exceeding the threshold volume.

7. The display apparatus of claim 1, wherein the instructions, when executed by the one or more processors, cause the display apparatus to control the audio output device to output the sound by adding the compensation value to the volume of the sound that is output based on the volume of the sound that is output being less than a predetermined reference volume.

8. The display apparatus of claim 1, wherein the instructions, when executed by the one or more processors, cause the display apparatus to:
determine whether content is changed based on the content data; and
re-determine the first average volume and the threshold volume based on the content being changed.

9. The display apparatus of claim 1, wherein the instructions, when executed by the one or more processors, cause the display apparatus to adjust the volume of the sound to be constant.

10. A sound outputting method comprising:
receiving content data from a content source;
outputting a sound corresponding the content data;
determining a threshold volume based on a first average volume of the sound that is output for a first reference time;
determining a compensation value based on a second average volume of the sound that is output for a second reference time; and
adjusting a volume of the sound that is output based on the threshold volume and the compensation value.

11. The sound outputting method of claim 10, wherein the second reference time is shorter than the first reference time.

12. The sound outputting method of claim 10, wherein the determining the threshold volume comprises determining the threshold volume to be larger than the first average volume.

13. The sound outputting method of claim 12, wherein the determining the threshold volume comprises
determining an auxiliary value based on at least one of a volume set for a display apparatus or the content data; and
determining the threshold volume by adding the auxiliary value to the first average volume.

14. The sound outputting method of claim 10, wherein the determining the compensation value comprises determining a difference between a predetermined reference volume and the second average volume as the compensation value.

15. The sound outputting method of claim 10, wherein the adjusting the volume of the sound that is output comprises adjusting the volume of the sound that is output to the threshold volume based on the volume of the sound that is output exceeding the threshold volume.

16. The sound outputting method of claim 10, wherein the adjusting the volume of the sound that is output comprises adding the compensation value to the volume of the sound that is output in response to the volume of the sound that is output being less than a predetermined reference volume.

17. The sound outputting method of claim 10, further comprising:
determining whether content is changed based on the content data; and
re-determining the first average volume and the threshold volume based on the content being changed.

18. The sound outputting method of claim 10, wherein the adjusting the volume of the sound that is output comprises adjusting the volume of the sound that is output to be constant.
